(19) United States
(12) Patent Application Publication
(10) Pub. No.: US 2025/0126038 A1
(43) Pub. Date: Apr. 17, 2025

(54) BANDWIDTH MEASUREMENT APPARATUS, DATA TRANSMISSION APPARATUS, AND METHOD

(71) Applicant: NEC Corporation, Minato-ku, Tokyo (JP)

(72) Inventors: Wenjing CUI, Tokyo (JP); Nobuo FUWA, Tokyo (JP); Yasuhiro MIZUKOSHI, Tokyo (JP); Yasunori FUTATSUGI, Tokyo (JP); Kiyotaka KAJI, Tokyo (JP); Kazuhiro FUKUOKA, Tokyo (JP); Kenichi SAWADA, Tokyo (JP)

(73) Assignee: NEC Corporation, Minato-ku, Tokyo (JP)

(21) Appl. No.: 18/833,972

(22) PCT Filed: Mar. 8, 2022
(86) PCT No.: PCT/JP2022/009960

§ 371 Date: Jul. 29, 2024

(51) Int. Cl. H04L 43/0882

(52) U.S. Cl. CPC H04L 43/0882

(57) ABSTRACT

Data transmission means divides data into one or more transmission packets in units of a predetermined size in conformity with a predetermined protocol, transmits the transmission packets to a reception apparatus, and receives an acknowledgement packet returned from the reception apparatus. Data size acquisition means acquires a data size of transmission data. Acknowledgement reception time acquisition means acquires a reception time of an acknowledgement packet. An available bandwidth calculation means calculates the available bandwidth in a network using the reception time of the acknowledgement packet when a sum of the data sizes of the transmission data in the predetermined time is double or more the predetermined size.

### TECHNICAL FIELD

The present disclosure relates to a bandwidth measurement apparatus, a data transmission apparatus, a method, and a computer-readable medium.

### BACKGROUND ART

As related art, Patent Literature 1 discloses bandwidth estimation using a transmission control protocol (TCP) acknowledgement function. A system described in Patent Literature 1 includes a headquarter server positioned at a center and a client terminal connected to the headquarter server via a communication path. In the client terminal, a bandwidth estimation unit acquires packet transmission/reception information from a packet transmission/reception unit. The packet transmission/reception information includes a communication time of a transmission packet, a transmission packet size, and an acknowledgement reception time. The bandwidth estimation unit measures jitter for each response acknowledgement packet. The bandwidth estimation unit calculates a dispersion interval by using the acknowledgement reception time and the jitter. The bandwidth estimation unit estimates an available bandwidth of the communication path based on a dispersion interval and a sum of transmission packet sizes.

### CITATION LIST

### Patent Literature

Patent Literature 1: Japanese Unexamined Patent Application Publication No. 2020-107975 A

### SUMMARY OF INVENTION

### Technical Problem

Patent Literature 1 describes that bandwidth estimation accuracy is improved by changing a maximum transmission unit (MTU) and increasing the number of communication packets. However, when the MTU is changed in order to improve the bandwidth estimation accuracy, the size of data that can be transmitted with one packet is reduced. Thus, there is a possibility of communication efficiency deteriorating.

In view of the above circumstances, an object of the present disclosure is to provide a bandwidth measurement apparatus, a data transmission apparatus, a method, and a computer-readable medium capable of accurately measuring an available bandwidth without deterioration in communication efficiency.

### Solution to Problem

In order to achieve the above object, as a first aspect, the present disclosure provides a bandwidth measurement apparatus. The bandwidth measurement apparatus includes: data size acquisition means for acquiring a data size of transmission data transmitted to a reception apparatus from a data transmission apparatus that divides data into one or more transmission packets in units of a predetermined size in conformity with a predetermined protocol and transmits the transmission data to the reception apparatus; acknowledgement reception time acquisition means for acquiring a reception time of an acknowledgement packet returned from the reception apparatus that has received the transmission packet to the data transmission apparatus; and available bandwidth calculation means for calculating an available bandwidth in a network used to transmit the transmission data using a reception time of the acknowledgement packet when a sum of data sizes of the transmission data in a predetermined time is double or more the predetermined size.

As a second aspect, the present disclosure provides a data transmission apparatus. The data transmission apparatus includes: data transmission means for dividing transmission data into one or more transmission packets in units of a predetermined size in conformity with a predetermined protocol, transmitting the transmission packet to a reception apparatus, and receiving an acknowledgement packet for the transmission packet from the reception apparatus; and bandwidth measurement means for measuring an available bandwidth in a network used to transmit the transmission data using the acknowledgement packet. The bandwidth measurement means includes data size acquisition means for acquiring a data size of the transmission data, acknowledgement reception time acquisition means for acquiring a reception time of the acknowledgement packet, and available bandwidth calculation means for calculating the available bandwidth using the reception time of the acknowledgement packet when a sum of data sizes of the transmission data in a predetermined time is double or more the predetermined size.

As a third aspect, the present disclosure provides a bandwidth measurement method. The bandwidth measurement method includes: acquiring a data size of transmission data transmitted to a reception apparatus from a data transmission apparatus that divides data into one or more transmission packets in units of a predetermined size in conformity with a predetermined protocol and transmits the transmission data to the reception apparatus; acquiring a reception time of an acknowledgement packet returned from the reception apparatus that has received the transmission packet to the data transmission apparatus; and calculating an available bandwidth in a network used to transmit the transmission data using a reception time of the acknowledgement packet when a sum of data sizes of the transmission data in a predetermined time is double or more the predetermined size.

As a fourth aspect, the present disclosure provides a data transmission method. The data transmission method includes: dividing transmission data into one or more transmission packets in units of a predetermined size in conformity with a predetermined protocol; transmitting the transmission packet to a reception apparatus; receiving an acknowledgement packet for the transmission packet from the reception apparatus; and acquiring a reception time of the acknowledgement packet; and calculating an available bandwidth in a network used to transmit the transmission data using a reception time of the acknowledgement packet when a sum of data sizes of the transmission data in a predetermined time is double or more the predetermined size.

As a fifth aspect, the present disclosure provides a computer-readable medium. The computer-readable medium stores a program causing a processor to execute processes including: acquiring a data size of transmission data transmitted to a reception apparatus from a data transmission apparatus that divides data into one or more transmission packets in units of a predetermined size in conformity with a predetermined protocol and transmits the transmission data to the reception apparatus; acquiring a reception time of an acknowledgement packet returned from the reception apparatus that has received the transmission packet to the data transmission apparatus; and calculating an available bandwidth in a network used to transmit the transmission data using a reception time of the acknowledgement packet when a sum of data sizes of the transmission data in a predetermined time is double or more the predetermined size.

As a sixth aspect, the present disclosure provides a computer-readable medium. The computer-readable medium stores a program causing a processor to execute processes including: dividing transmission data into one or more transmission packets in units of a predetermined size in conformity with a predetermined protocol; transmitting the transmission packet to a reception apparatus; receiving an acknowledgement packet for the transmission packet from the reception apparatus; acquiring a reception time of the acknowledgement packet; and calculating an available bandwidth in a network used to transmit the transmission data using a reception time of the acknowledgement packet when a sum of data sizes of the transmission data in a predetermined time is double or more the predetermined size.

### Advantageous Effects of Invention

The bandwidth measurement apparatus, the data transmission apparatus, the method, and the computer-readable medium according to the present disclosure can accurately measure an available bandwidth without deterioration in communication efficiency.

### BRIEF DESCRIPTION OF DRAWINGS

FIG. 1 is a block diagram illustrating an overall configuration of a data transmission apparatus according to the present disclosure.

FIG. 2 is a block diagram illustrating a data transmission system including a data transmission apparatus according to a first example embodiment of the present disclosure.

FIG. 3 is a block diagram illustrating a configuration example of a mobile body.

FIG. 4 is a block diagram illustrating a configuration example of a bandwidth measurement unit.

FIG. 5 is a diagram schematically illustrating data transmission and ACK packet reception.

FIG. 6 is a flowchart illustrating an operation procedure in the data transmission apparatus.

FIG. 7 is a diagram schematically illustrating data transmission and ACK packet reception.

FIG. 8 is a flowchart illustrating an operation procedure of a data transmission apparatus according to a third example embodiment.

FIG. 9 is a block diagram illustrating an example of a hardware configuration of a computer apparatus.

### EXAMPLE EMBODIMENT

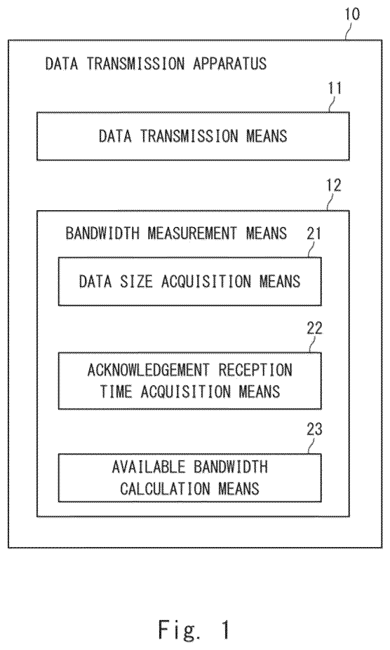

Before describing example embodiments of the present disclosure, an overview of the present disclosure will be described. FIG. 1 illustrates a schematic configuration of a data transmission apparatus according to the present disclosure. A data transmission apparatus 10 includes data transmission means 11 and bandwidth measurement means 12. The data transmission means 11 divides transmission data into one or more transmission packets in units of predetermined sizes in conformity with a predetermined protocol, and transmits the divided transmission packets to a reception apparatus. When the transmission packets are received, the reception apparatus returns an acknowledgement packet for the transmission packet to the data transmission means 11. The data transmission means 11 receives an acknowledgement packet from the reception apparatus.

The bandwidth measurement means 12 measures an available bandwidth in a network used to transmit data using an acknowledgement packet returned from the reception apparatus. Here, “bandwidth” indicates a communication speed. A wide bandwidth means a high communication speed. The bandwidth measurement means 12 is not necessarily included in the data transmission apparatus 10. The bandwidth measurement means 12 may be configured as an independent apparatus (bandwidth measurement apparatus).

The bandwidth measurement means 12 includes data size acquisition means 21, acknowledgement reception time acquisition means 22, and available bandwidth calculation means 23. The data size acquisition means 21 acquires a data size of the transmission data transmitted from the data transmission means 11. The acknowledgement reception time acquisition means 22 acquires a reception time of an acknowledgement packet. When a sum of data sizes of the transmission data in a predetermined time is double or more the predetermined size, the available bandwidth calculation means 23 calculates an available bandwidth using the reception time of the acknowledgement packet.

In the present disclosure, when the data size of the transmission data is double or more the predetermined size, the data transmission means 11 divides the transmission data into two or more transmission packets and transmits the divided two or more transmission packets to the reception apparatus. When the data size of the transmission data is double or more the predetermined size, a data size of a payload is equal to the predetermined size in at least two of the divided transmission packets. The bandwidth measurement means 12 measures the available bandwidth when the data size of the transmission data is double or more the predetermined size. In the present disclosure, since the available bandwidth is measured using an acknowledgement packet with immediacy, accuracy of the measured available bandwidth is high. Therefore, in the present disclosure, in order to improve the accuracy of available bandwidth measurement, it is not necessary to change a data division size. Accordingly, the bandwidth measurement means 12 can accurately measure the available bandwidth without deterioration in the communication efficiency.

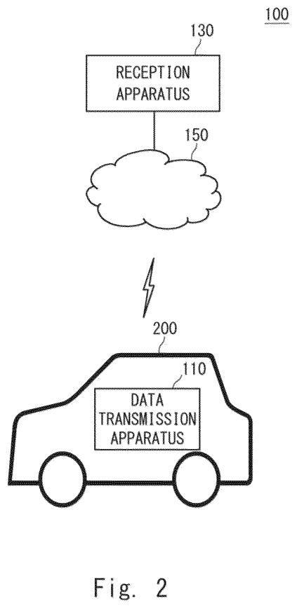

Hereinafter, an example embodiment of the present disclosure will be described in detail. FIG. 2 illustrates a data transmission system including the data transmission apparatus according to the first example embodiment of the present disclosure. The data transmission system 100 includes a reception apparatus 130 and a mobile body 200. The reception apparatus 130 is connected to the mobile body 200 via a network 150. The network 150 includes, for example, a wireless communication network using a communication line standard such as long term evolution (LTE). The network 150 may include a wireless communication network, such as WiFi (registered trademark) or a 5th generation mobile communication system.

The mobile body 200 includes a data transmission apparatus 110. The data transmission apparatus 110 transmits data to the reception apparatus 130 via the network 150. The mobile body 200 is configured as, for example, a land vehicle such as an automobile, a bus, a taxi, or a truck. The mobile body 200 may be configured such that automated driving (autonomous driving) is possible based on information from a sensor mounted on the mobile body. The mobile body 200 may be configured to be switchable between, for example, automated driving and manual driving by a driver in the vehicle. For example, the mobile body 200 may be switched from the manual driving to the automated driving or from the automated driving to the manual driving in response to an instruction transmitted from a remote monitoring apparatus (not illustrated). The mobile body 200 may be a railway, a ship, or an aircraft or may be a mobile robot such as an automated guided vehicle (AGV).

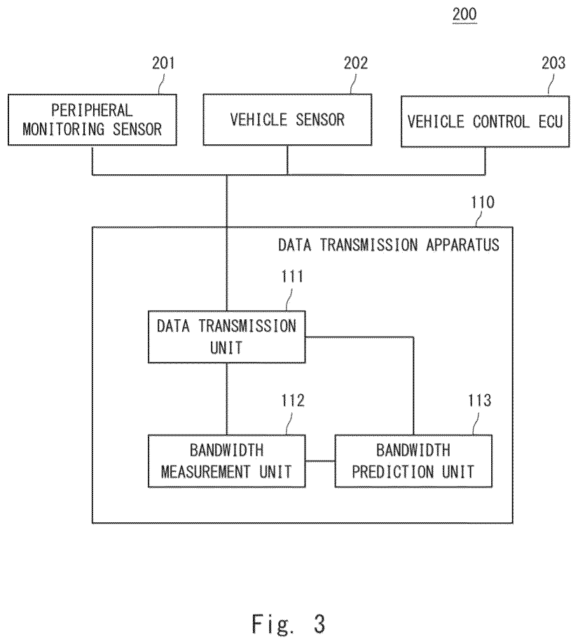

FIG. 3 illustrates a configuration example of the mobile body 200. The mobile body 200 includes a peripheral monitoring sensor 201, a vehicle sensor 202, a vehicle control electric control unit (ECU) 203, and a data transmission apparatus 110. In the mobile body 200, these constituent elements are configured to be able to communicate with one another through a network such as a local area network (LAN) or a controller area network (CAN).

The peripheral monitoring sensor 201 is a sensor that monitors surrounding situations of the mobile body 200. The peripheral monitoring sensor 201, for example, includes a camera, a radar, and a light detection and ranging (LiDAR). The peripheral monitoring sensor 201 may, for example, include a plurality of cameras to capture images ahead, behind, on the right-and side, and on the left-sand side of the vehicle. The peripheral monitoring sensor 201 may include a camera that captures an image of the interior of the mobile body 200.

The vehicle sensor 202 is a sensor that detects various states of the mobile body 200. The vehicle sensor 202 includes sensors such as a vehicle speed sensor that detects a vehicle speed, a steering sensor that detects a steering angle, an accelerator opening sensor that detects the degree of opening of an accelerator pedal, and a brake pedal force sensor that detects a depression amount of a brake pedal, and the like.

The vehicle control ECU 203 is an electronic control apparatus that performs travel control of the mobile body 200 or the like. In general, the electronic control apparatus includes a processor, a memory, an input/output (I/O), and a bus that connects them. Based on sensor information output by the vehicle sensor 202, the vehicle control ECU 203 executes various types of controls, such as control of a fuel injection amount, an engine ignition timing, and an assist amount of power steering.

The data transmission apparatus 110 performs wireless communication with the network 150 (see FIG. 2). The data transmission apparatus 110 includes a wireless communication antenna, a transmitter, and a receiver as a hardware configuration. The data transmission apparatus 110 includes one or more processors, one or more memories, an I/O, and a bus that connects them. At least some of the functions of the data transmission apparatus 110 are realized, for example, by causing a processor to execute a control program stored in the memory. The data transmission apparatus 110 corresponds to the data transmission apparatus 10 illustrated in FIG. 1.

The data transmission apparatus 110 includes a data transmission unit 111, a bandwidth measurement unit 112, and a bandwidth prediction unit 113. The data transmission unit 111 generates data to be transmitted to the reception apparatus 130 and transmits the generated data to the reception apparatus 130 via the network 150. The data transmission unit 111 performs data communication with the reception apparatus 130 in conformity with a predetermined protocol. In the present example embodiment, it is assumed that a protocol used for communication is TCP.

The data transmission unit 111 transmits, for example, sensor information acquired by at least one of the peripheral monitoring sensor 201 and the vehicle sensor 202 to the reception apparatus 130. For example, the data transmission unit 111 transmits a camera video acquired by the peripheral monitoring sensor 201 to the reception apparatus 130. Alternatively or additionally, the sensor information such as a vehicle speed acquired by the vehicle sensor 202 may be transmitted to the reception apparatus 130. The data transmission unit 111 may acquire data from the vehicle control ECU 203 and transmit the acquired data to the reception apparatus 130.

The data transmission unit 111 transmits the acquired data to the reception apparatus 130 in real time. Alternatively, the data transmission unit 111 may accumulate data for the mobile body 200 and transmit the accumulated data to the reception apparatus 130. For example, the data transmission unit 111 may accumulate data until a predetermined condition is satisfied, and transmit the accumulated data to the reception apparatus 130 when the predetermined condition is satisfied.

When the size of the transmission data exceeds a predetermined size (for example, a maximum TCP segment size), the data transmission unit 111 divides the transmission data into a plurality of transmission packets in units of a predetermined size under the TCP protocol control. The maximum TCP segment size is defined as a maximum segment size (MSS) and is normally 1460 bytes. The data transmission unit 111 transmits the divided transmission packets (TCP packets) to the reception apparatus 130. When the TCP packets are received, the reception apparatus 130 returns an acknowledgement (ACK) packet indicating that the data has been received to the data transmission unit 111 for each packet. The data transmission unit 111 receives the ACK packet (ACK packet) from the reception apparatus 130. The data transmission unit 111 corresponds to the data transmission means 11 illustrated in FIG. 1.

The bandwidth measurement unit 112 measures an available bandwidth in the network 150 using the reception time of the ACK packet. Here, due to the characteristics of TCP, when a data size of the transmission data is less than double of the MSS, there is no immediacy of the ACK packet. When there is no immediacy of the ACK packet, reliability of the available bandwidth measured using the reception time of the ACK packet is low. Conversely, when the data size of the transmission data is double or more the MSS, the ACK has immediacy. Accordingly, in the present example embodiment, when a total data size of the transmission data for the predetermined time is double or more the predetermined size, the bandwidth measurement unit 112 measures the available bandwidth (throughput) using the reception time of the ACK packet. The bandwidth measurement unit 112 corresponds to the bandwidth measurement means 12 illustrated in FIG. 1.

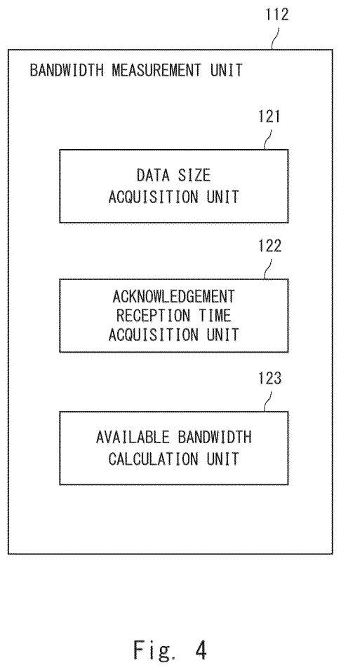

FIG. 4 illustrates a configuration example of the bandwidth measurement unit 112. The bandwidth measurement unit 112 includes a data size acquisition unit 121, an acknowledgement reception time acquisition unit 122, and an available bandwidth calculation unit 123. The data size acquisition unit 121 acquires the data size of the transmission data transmitted from the data transmission unit 111. When the data size of the transmission data is double or more the MSS, the acknowledgement reception time acquisition unit 122 acquires the reception time of the ACK packet for the transmission packet. The available bandwidth calculation unit 123 calculates the throughput in the network 150 as a current available bandwidth based on a difference between the reception times of two ACK packets. The data size acquisition unit 121, the acknowledgement reception time acquisition unit 122, and the available bandwidth calculation unit 123 correspond to the data size acquisition means 21, the acknowledgement reception time acquisition means 22, and the available bandwidth calculation means 23 illustrated in FIG. 1, respectively.

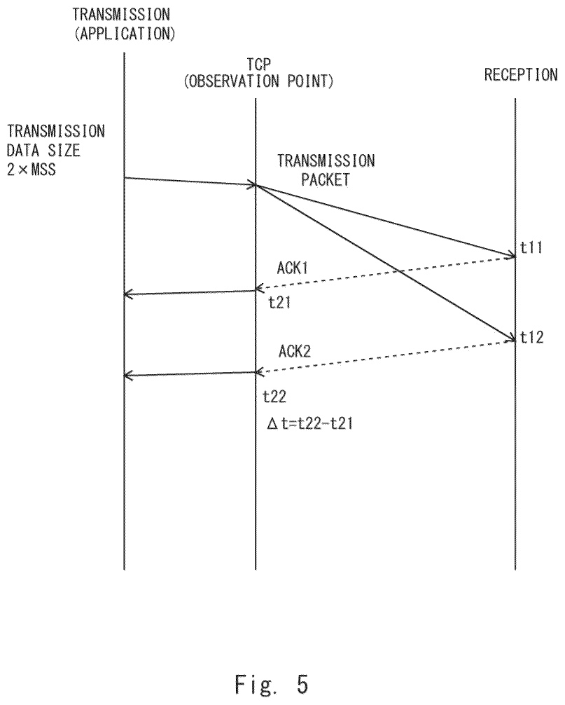

FIG. 5 schematically illustrates data transmission and ACK packet reception. In the data transmission unit 111, an application for data transmission generates transmission data and generates a TCP packet from the generated transmission data. When the data size of the transmission data is double or more the MSS, the data transmission unit 111 divides the transmission data into two or more TCP segments (transmission packets). Here, it is assumed that the data size of the transmission data is double of the MSS. In this case, the data transmission unit 111 generates two transmission packets of which a payload size is the MSS. Each transmission packet includes a sequence number.

The reception apparatus 130 receives a transmission packet with the sequence number “1” at time t11 and returns an ACK packet (ACK1) to the data transmission unit 111. The data transmission unit 111 receives the ACK1 at time t21. The reception apparatus 130 receives a transmission packet with the sequence number “2” at time t12 and returns an ACK packet (ACK2) to the data transmission unit 111. The data transmission unit 111 receives AKC2 at time t22. Time t11 and time t21 are substantially the same time, and time t12 and time t22 are substantially the same time.

In the bandwidth measurement unit 112, the data size acquisition unit 121 acquires a data size of the transmission data. The acknowledgement reception time acquisition unit 122 determines whether the data size of the transmission data is double or more the MSS. When the data size of the transmission data is double or more the MSS, the acknowledgement reception time acquisition unit 122 acquires a reception time of the ACK packet. The acknowledgement reception time acquisition unit 122 acquires, for example, reception time t21 of the ACK packet for the transmission packet with the sequence number “1” and reception time t22 of the ACK packet for the transmission packet with the sequence number “2”.

The available bandwidth calculation unit 123 calculates the current available bandwidth based on a reception interval between the ACK packets and the MSS. Specifically, the available bandwidth calculation unit 123 calculates the current available bandwidth [byte per second (Bps)] from a reception interval Δt=t22−t21 [second] of the ACK packet and MSS [Byte] using the following formula.

Available bandwidth (throughput)=MSS/Δt

If the data size of the transmission data is less than double of the MSS, the available bandwidth calculation unit 123 does not calculate the current available bandwidth. In this case, the acknowledgement reception time acquisition unit 122 may not acquire the reception time of the ACK packet.

Referring back to FIG. 3, the bandwidth prediction unit (bandwidth prediction means) 113 acquires a measurement result of the current available bandwidth from the bandwidth measurement unit 112. The bandwidth prediction unit 113 predicts an available bandwidth in the near future based on a measurement result of the available bandwidth. The bandwidth prediction unit 113 includes a bandwidth prediction engine. The bandwidth prediction engine predicts an available bandwidth in the near future based on, for example, a measurement result of the available bandwidth in a past time series. The bandwidth prediction engine predicts the available bandwidth at the next time from, for example, a change pattern of the available bandwidth in the past in the network 150. For example, the bandwidth prediction engine predicts the available bandwidth at the next time from the measurement result of the available bandwidth for the past 3 seconds every 0.5 seconds.

The data transmission unit 111 acquires the prediction result of the available bandwidth from the bandwidth prediction unit 113, and adjusts the data size (that is, a data transmission amount) of the transmission data using the acquired prediction result. For example, the data transmission unit 111 adjusts the data size of the transmission data so that a throughput during data transmission does not become greater than the predicted available bandwidth. When the data transmission amount exceeds the available bandwidth, a delay occurs in data transmission or the like, and reliability of data received by the reception apparatus 130 deteriorates. In the present example embodiment, since the data size of the transmission data is adjusted according to the prediction result of the available bandwidth, the data transmission can be performed within a range in which the data transmission amount does not exceed the available bandwidth.

For example, when video data is transmitted to the reception apparatus 130, the data transmission unit 111 adjusts the data size of the transmission data by adjusting quality of the video data. For example, the data transmission unit 111 adjusts the data size of the transmission data by adjusting at least some of the compression rate, a resolution, and a frame rate of the video data. The data transmission unit 111 may adjust the data size of the transmission data by increasing or decreasing the number of pieces of data to be transmitted (the number of items). For example, when video data of the plurality of cameras is transmitted to the reception apparatus 130 and there is no room for available bandwidth, the data transmission unit 111 may remove the video data of a camera with low priority from the transmission data.

The functions of the bandwidth measurement unit 112 and the bandwidth prediction unit 113 can be realized by one or more processors (not illustrated) operating according to programs read from one or more memories. The bandwidth measurement unit 112 and the bandwidth prediction unit 113 may be configured as a single apparatus, or may be configured as individual apparatuses. At least one of the bandwidth measurement unit 112 and the bandwidth prediction unit 113 may be included in the data transmission unit 111.

The reception apparatus 130 receives the data transmitted from the data transmission apparatus 110. The reception apparatus 130 is disposed, for example, in a remote monitoring center that remotely monitors the mobile body 200. The data received by the reception apparatus 130 is displayed on a display apparatus (not illustrated) or the like. For example, when video data ahead, behind, on the right-hand side, and on the left-hand side of a vehicle is transmitted from the data transmission apparatus 110, these videos are displayed on the display screen. An observer monitors a display screen to monitor whether there is obstacle in traveling of the mobile body 200. The data received by the reception apparatus 130 may be recorded in a database (not illustrated). In the present example embodiment, a use purpose of the data received by the reception apparatus 130 is not particularly limited.

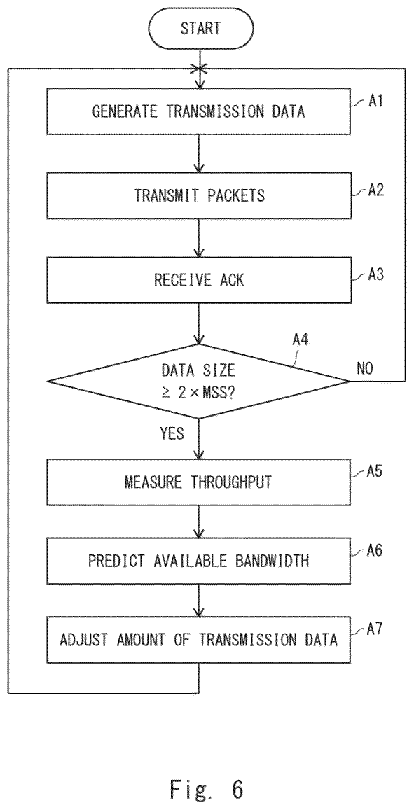

Next, an operation procedure will be described. FIG. 6 illustrates an operation procedure (data transmission method) in the data transmission apparatus 110. The data transmission unit 111 generates transmission data (step A1). The data transmission unit 111 generates a transmission packet from the transmission data and transmits the transmission packet to the reception apparatus 130 via the network 150 (step A2). When the data size of the transmission data is double or more the MSS, the data transmission unit 111 transmits two or more transmission packets to the reception apparatus 130 in step A2.

When the transmission packet is received, the reception apparatus 130 returns an ACK packet to the data transmission apparatus 110. The data transmission unit 111 receives an ACK packet for the transmission packet (step A3). When a plurality of transmission packets have been transmitted in step A2, the data transmission unit 111 receives a plurality of ACK packets in step A3.

In the bandwidth measurement unit 112, the data size acquisition unit 121 (see FIG. 4) acquires the data size of the transmission data. The acknowledgement reception time acquisition unit 122 determines whether the data size of the transmission data is double or more the MSS (step A4). When it is determined that the data size of the transmission data is double or more the MSS, the acknowledgement reception time acquisition unit 122 acquires the reception time of each of two or more ACK packets.

The available bandwidth calculation unit 123 calculates the throughput of the network 150 during data transmission based on a difference in the reception time of the ACK packet and the MSS (step A5). When it is determined in step A4 that the data size of the transmission data is not double or more the MSS, the process returns to step A1, and next transmission data is generated. Steps A4 and A5 correspond to the operation procedure (bandwidth measurement method) of the bandwidth measurement unit 112.

The bandwidth prediction unit 113 predicts the available bandwidth of the network at the next time based on the throughput calculated in step A5 (step A6). The data transmission unit 111 adjusts a transmission data amount according to the available bandwidth of the network predicted in step A6 (step A7). Thereafter, the process returns to step A1, and the data transmission unit 111 generates transmission data with the amount of transmission data adjusted in step A7.

In the present example embodiment, when data with a data size of double or more the MSS is transmitted, the bandwidth measurement unit 112 calculates the available bandwidth using the reception interval between the ACK packets. When data with a data size less than double of the MSS is transmitted, the bandwidth measurement unit 112 does not calculate the available bandwidth. Due to characteristics of a protocol used for communication between the data transmission apparatus 110 and the reception apparatus 130, an ACK packet is immediately replied when a transmission packet of which the data size is double or more the MSS is transmitted. Since the bandwidth measurement unit 112 measures the available bandwidth using the ACK packet with immediacy using such characteristics, the available bandwidth can be accurately measured.

In the present example embodiment, since the bandwidth measurement unit 112 can accurately measure the available bandwidth, it is not necessary to change the MSS or the MTU in order to improve the estimation accuracy of the available bandwidth. If the MSS or the MTU is set to a small value in order to increase the number of transmission packets, the communication efficiency decreases. In the present example embodiment, since it is not necessary to change the MSS or the MTU in order to accurately measure the available bandwidth, the available bandwidth can be accurately measured without deterioration in the communication efficiency.

In the present example embodiment, the bandwidth prediction unit 113 predicts the available bandwidth at the next time using the available bandwidth measured by the bandwidth measurement unit 112. In the present example embodiment, since the available bandwidth is predicted using the accurately measured available bandwidth, the accuracy of the prediction of the available bandwidth can be improved. The data transmission unit 111 can inhibit a data transmission delay or the like by adjusting the amount of transmission data according to the predicted available bandwidth.

Next, a second example embodiment will be described. A configuration of a data transmission apparatus according to a second example embodiment of the present disclosure may be similar to the configuration of the data transmission apparatus 110 described in the first example embodiment illustrated in FIG. 3. In the present example embodiment, a configuration of the bandwidth measurement unit 112 may be similar to the configuration of the bandwidth measurement unit 112 described in the first example embodiment illustrated in FIG. 4. In the present example embodiment, the bandwidth measurement unit 112 measures a current available bandwidth by calculating throughputs for a plurality of pairs of transmission packets and averaging the calculated plurality of throughputs. Other operations may be the same as the operations in the first example embodiment.

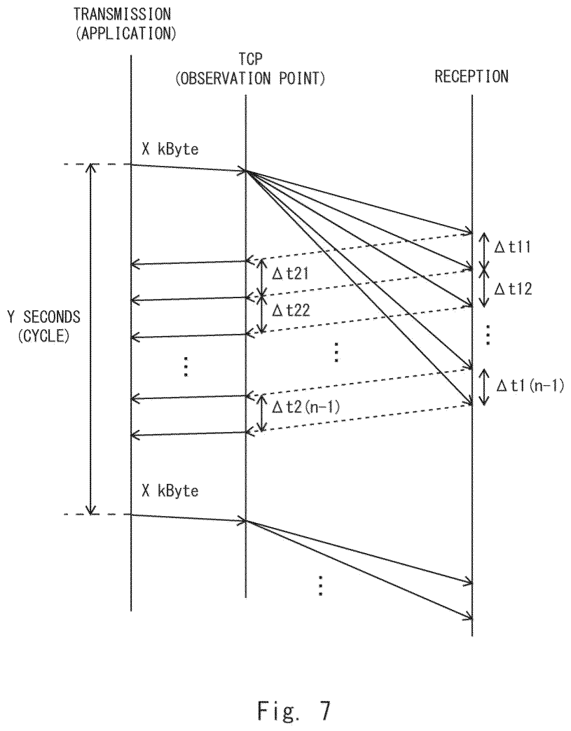

FIG. 7 schematically illustrates data transmission and ACK packet reception. Here, it is assumed that the data transmission unit 111 periodically transmits transmission data with X [Byte] to the reception apparatus 130 with Y [sec] as a data transmission cycle. On assumption that n is an integer indicating the number of divisions of the TCP segment, the number of divisions n is n=X/MSS (fractional rounding up). The data transmission unit 111 divides the transmission data of X [Byte] into n transmission packets with sequence numbers “1” to “n”. Here, it is assumed that X [Byte]=MSS×n. In that case, a data size of a payload of each transmission packet is the MSS.

When the transmission packets with the sequence numbers “1” to “n” are received, the reception apparatus 130 returns a total of n ACK packets to the data transmission unit 111. The data transmission unit 111 receives the returned n ACK packets. In the bandwidth measurement unit 112, the acknowledgement reception time acquisition unit 122 (see FIG. 4) acquires a reception time of each of the n ACK packets. The available bandwidth calculation unit 123 calculates a difference Δt21 to Δt2(n-1) between reception times of two ACK packets for a pair of transmission packets of consecutive sequence numbers as an ACK packet reception interval. ACK packet reception intervals Δt21 to Δt2(n-1) are substantially equal to transmission packet reception intervals Δt11 to Δt1(n-1), respectively, in the reception apparatus 130.

In the present example embodiment, the available bandwidth calculation unit 123 calculates the current available bandwidth based on n-1 ACK packet reception intervals and the MSS. For example, the available bandwidth calculation unit 123 calculates a throughput for each pair of transmission packets with consecutive sequence numbers and calculates an average of the throughputs as the current available bandwidth. Specifically, the available bandwidth calculation unit 123 calculates the current available bandwidth using the following formula.

$$Available bandwidth = ( MSS / Δ t 21 + MSS / Δ t 22 + … + MSS / Δ t 2 ( n - 1 ) ) / ( n - 1 )$$

If the data size X [Byte] of the transmission data is not an integral multiple of the MSS and a relationship of (n-1)×MSS<X<n×MSS is satisfied, the available bandwidth calculation unit 123 excludes the ACK packet (a reception time of the ACK packet) for the packet with the sequence number “n” from calculation of the available bandwidth. In that case, the available bandwidth calculation unit 123 calculates the available bandwidth using the ACK packet reception intervals Δt21 to Δt2(n-2).

In the present example embodiment, the bandwidth measurement unit 112 calculates the ACK packet reception interval for two consecutive transmission packets of which the data size of the payload is equal to the MSS. The bandwidth measurement unit 112 measures the current available bandwidth using a plurality of ACK packet reception intervals. In the present example embodiment, it is possible to distribute jitter of the ACK packet by averaging throughputs during transmission of two consecutive transmission packets. In other words, fluctuation of the reception time of the ACK packet can be inhibited. Therefore, it is considered that the present example embodiment can improve the accuracy of measurement of the available bandwidth, compared with the first example embodiment. Other effects are similar to those in the first example embodiment.

Next, a third example embodiment of the present disclosure will be described. A configuration of a data transmission apparatus according to the third example embodiment of the present disclosure may be similar to the configuration of the data transmission apparatus 110 described in the first example embodiment illustrated in FIG. 3. In the present example embodiment, a configuration of the bandwidth measurement unit 112 may be similar to the configuration of the bandwidth measurement unit 112 described in the first example embodiment illustrated in FIG. 4. In the present example embodiment, when there is no spare bandwidth on a line used for transmission of an ACK packet, that is, a communication line in a direction from the reception apparatus 130 to the data transmission apparatus 110 in the network 150 (see FIG. 2), the bandwidth measurement unit 112 does not measure the available bandwidth. Other operations may be similar to the operations described in the first or second example embodiment.

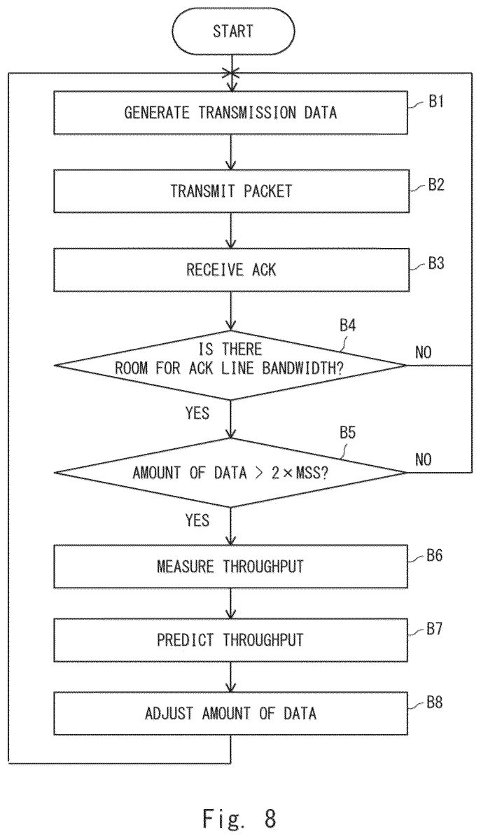

FIG. 8 illustrates an operation procedure of the data transmission apparatus 110 in the present example embodiment. The data transmission unit 111 generates transmission data (step B1). The data transmission unit 111 generates a transmission packet from the transmission data and transmits the transmission packet to the reception apparatus 130 through the network 150 (step B2). When the transmission packet is received, the reception apparatus 130 returns an ACK packet to the data transmission apparatus 110. The data transmission unit 111 receives an ACK packet for the transmission packet (step B3). Steps B1 to B3 may be similar to steps A1 to A3 shown in FIG. 6.

The bandwidth measurement unit 112 determines whether there is room for a line (also referred to as an ACK line) used to transmit the ACK packet in the network 150 (step B4). In the bandwidth measurement unit 112, for example, when the ACK packet for the transmission packet is not received despite elapse of a predetermined time from the transmission of the transmission packet, the acknowledgement reception time acquisition unit 122 (see FIG. 4) determines that there is no room for an ACK line. When the ACK packet is received within a predetermined time from the transmission of the transmission packet, the acknowledgement reception time acquisition unit 122 determines that there is room for the ACK line. When it is determined in step B4 that there is no room for the ACK line, the process returns to step B1 and the available bandwidth is not measured.

When it is determined in step B4 that there is room for the ACK line, the data size acquisition unit 121 acquires the data size of the transmission data. The acknowledgement reception time acquisition unit 122 determines whether the data size of the transmission data is double or more the MSS (step B5). When it is determined that the data size of the transmission data is double or more the MSS, the acknowledgement reception time acquisition unit 122 acquires the reception time of each of two or more ACK packets. The available bandwidth calculation unit 123 calculates a throughput of the network 150 during data transmission based on a difference in the reception time of the ACK packet and the MSS (step B6). In step B5, when it is determined that the data size of the transmission data is not double or more the MSS, the process returns to step B1, and next transmission data is generated.

The bandwidth prediction unit 113 predicts an available bandwidth of the network at the next time based on the throughput calculated in step B5 (step B7). The data transmission unit 111 adjusts an amount of transmission data according to the available bandwidth of the network predicted in step B7 (step B8). Thereafter, the process returns to step B1, and the data transmission unit 111 generates transmission data with the amount of transmission data adjusted in step B8. Steps B5 to B8 may be similar to steps A4 to A7 illustrated in FIG. 6.

In the present example embodiment, the bandwidth measurement unit 112 determines whether there is room for the ACK line, and measures the available bandwidth when it is determined that there is room for the ACK line. When there is no room for the ACK line, a delivery delay of the ACK packet occurs, and it is considered that the accuracy of estimation of the available bandwidth using the ACK packet reception interval decreases. In the present example embodiment, the available bandwidth can be accurately measured by measuring the available bandwidth when there is room for the ACK line. Other effects are similar to those described in the first or second example embodiment.

In the above example embodiment, an example in which the available bandwidth measured by the bandwidth measurement unit 112 is used to predict the available bandwidth at a next time in the bandwidth prediction unit 113 has been described. However, the present disclosure is not limited thereto. That is, the purpose for using the measured available bandwidth is not particularly limited to the prediction of the available bandwidth. For example, the measured available bandwidth can be used in an application program that performs any processing in accordance with the available bandwidth.

In the above example embodiment, the example in which the data transmission apparatus 110 is mounted on the mobile body 200 has been described. However, the present disclosure is not limited thereto. The data transmitted by the data transmission apparatus 110 is not limited to data related to the mobile body 200. The network 150 does not necessarily include a wireless communication network, and may be a wired network.

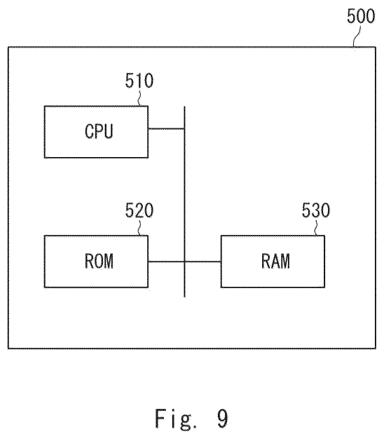

In the present disclosure, the data transmission unit 111, the bandwidth measurement unit 112, and the bandwidth prediction unit 113 can be configured as apparatuses such as a computer apparatus. FIG. 9 illustrates an example of a hardware configuration of a computer apparatus that can be used as the data transmission unit 111, the bandwidth measurement unit 112, and the bandwidth prediction unit 113. The computer apparatus 500 includes a processor 510, a ROM 520, and a RAM 530. In the computer apparatus 500, the processor 510, the ROM 520, and the RAM 530 are connected to each other via a bus. Although not illustrated, the computer apparatus 500 may include other circuits such as a peripheral circuit, a communication circuit, and an interface circuit.

The ROM 520 is a nonvolatile storage device. As the ROM 520, for example, a semiconductor storage device such as a flash memory that has a relatively small capacity is used. The ROM 520 stores a program executed by the processor 510.

The program described above includes a group of commands (or software codes) for causing a computer to perform one or more functions described in the example embodiments when the program is read by the computer. The program may be stored in a non-transitory computer-readable medium or a tangible storage medium. As an example and not by way of limitation, a computer-readable medium or tangible storage medium includes a RAM, a ROM, a flash memory, a solid-state drive (SSD) or other memory technology, a compact disc (CD), a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, transitory computer-readable media or communication media include electrical, optical, acoustic, or other forms of propagated signals.

The RAM 530 is a volatile storage device. As the RAM 530, any of various semiconductor memory devices such as a dynamic random access memory (DRAM) or a static random access memory (SRAM) is used. The RAM 530 can be used as an internal buffer that temporarily stores data and the like. The processor 510 loads the program stored in the ROM 520 on the RAM 530 and executes the program. At least some of the functions of the data transmission unit 111, the bandwidth measurement unit 112, and the bandwidth prediction unit 113 can be realized by the processor 510 that executes a program.

Although example embodiments according to the present disclosure have been described above in detail, the present disclosure is not limited to the above-described example embodiments, and the present disclosure also includes those that are obtained by making changes or modifications to the above-described example embodiments without departing from the gist of the present disclosure.

For example, some or all of the example embodiments disclosed above can be described as, but not limited to, the following supplementary notes.

### [Supplementary Note 1]

A bandwidth measurement apparatus including:
data size acquisition means for acquiring a data size of transmission data transmitted to a reception apparatus from a data transmission apparatus that divides data into one or more transmission packets in units of a predetermined size in conformity with a predetermined protocol and transmits the transmission data to the reception apparatus;
acknowledgement reception time acquisition means for acquiring a reception time of an acknowledgement packet returned from the reception apparatus that has received the transmission packet to the data transmission apparatus; and
available bandwidth calculation means for calculating an available bandwidth in a network used to transmit the transmission data using a reception time of the acknowledgement packet when a sum of data sizes of the transmission data in a predetermined time is double or more the predetermined size.

### [Supplementary Note 2]

The bandwidth measurement apparatus according to Supplementary Note 1, wherein the available bandwidth calculation means calculates the available bandwidth based on the predetermined size and an interval between reception times of two acknowledgement packets for two transmission packets transmitted from the data transmission apparatus to the reception apparatus.

### [Supplementary Note 3]

The bandwidth measurement apparatus according to Supplementary Note 1 or 2, wherein the available bandwidth is calculated for each pair of transmission packets of which a payload data size is the predetermined size using the interval between the reception times of the acknowledgement packets for the pair of transmission packets, and an average of the available bandwidths calculated for each pair is calculated as the available bandwidth.

### [Supplementary Note 4]

The bandwidth measurement apparatus according to Supplementary Note 3, wherein
the transmission packets have sequence numbers, and
the available bandwidth calculation means calculates an available bandwidth using an interval between the reception times of the acknowledgement packets for the pair of transmission packets of which the sequence numbers are consecutive.

### [Supplementary Note 5]

The bandwidth measurement apparatus according to any one of Supplementary Notes 1 to 4, wherein
the predetermined protocol is a transmission control protocol (TCP), and
the predetermined size is a maximum segment size (MSS) in the TCP.

### [Supplementary Note 6]

The bandwidth measurement apparatus according to any one of Supplementary Notes 1 to 5, wherein the available bandwidth calculation means does not calculate the available bandwidth when an acknowledgement packet for the transmission packet is not received in the data transmission apparatus within a predetermined time after transmission of the transmission packet.

### [Supplementary Note 7]

The bandwidth measurement apparatus according to any one of Supplementary Notes 1 to 6, wherein the available bandwidth calculation means does not calculate the available bandwidth when a data size of the transmission data is less than double of the predetermined size.

### [Supplementary Note 8]

A data transmission apparatus including:
data transmission means for dividing transmission data into one or more transmission packets in units of a predetermined size in conformity with a predetermined protocol, transmitting the transmission packet to a reception apparatus, and receiving an acknowledgement packet for the transmission packet from the reception apparatus; and
bandwidth measurement means for measuring an available bandwidth in a network used to transmit the transmission data using the acknowledgement packet, wherein
the bandwidth measurement means includes:
data size acquisition means for acquiring a data size of the transmission data,
acknowledgement reception time acquisition means for acquiring a reception time of the acknowledgement packet, and
available bandwidth calculation means for calculating the available bandwidth using the reception time of the acknowledgement packet when a sum of data sizes of the transmission data in a predetermined time is double or more the predetermined size.

### [Supplementary Note 9]

The data transmission apparatus according to Supplementary Note 8, wherein the available bandwidth calculation means calculates the available bandwidth based on the predetermined size and an interval between reception times of two acknowledgement packets for two transmission packets transmitted from the data transmission apparatus to the reception apparatus.

### [Supplementary Note 10]

The data transmission apparatus according to Supplementary Note 8 or 9, wherein the available bandwidth is calculated for each pair of transmission packets of which a payload data size is the predetermined size using the interval between the reception times of the acknowledgement packets for the pair of transmission packets, and an average of the available bandwidths calculated for each pair is calculated as the available bandwidth.

### [Supplementary Note 11]

The data transmission apparatus according to any one of Supplementary Notes 8 to 10, further including: bandwidth prediction means for predicting an available bandwidth based on the measured available bandwidth,
wherein the data transmission means adjusts a data amount of the transmission data in accordance with the predicted available bandwidth.

### [Supplementary Note 12]

A bandwidth measurement method including:
acquiring a data size of transmission data transmitted to a reception apparatus from a data transmission apparatus that divides data into one or more transmission packets in units of a predetermined size in conformity with a predetermined protocol and transmits the transmission data to the reception apparatus;
acquiring a reception time of an acknowledgement packet returned from the reception apparatus that has received the transmission packet to the data transmission apparatus; and
calculating an available bandwidth in a network used to transmit the transmission data using a reception time of the acknowledgement packet when a sum of data sizes of the transmission data in a predetermined time is double or more the predetermined size.

### [Supplementary Note 13]

A data transmission method including:
dividing transmission data into one or more transmission packets in units of a predetermined size in conformity with a predetermined protocol;
transmitting the transmission packet to a reception apparatus;
receiving an acknowledgement packet for the transmission packet from the reception apparatus;
acquiring a reception time of the acknowledgement packet; and
calculating an available bandwidth in a network used to transmit the transmission data using a reception time of the acknowledgement packet when a sum of data sizes of the transmission data in a predetermined time is double or more the predetermined size.

### [Supplementary Note 14]

The data transmission method according to Supplementary Note 13, further including:
predicting an available bandwidth based on the calculated available bandwidth; and
adjusting a data amount of the transmission data according to the predicted available bandwidth.

### [Supplementary Note 15]

A non-transitory computer-readable medium that stores a program causing a processor to execute processes including:
acquiring a data size of transmission data transmitted to a reception apparatus from a data transmission apparatus that divides data into one or more transmission packets in units of a predetermined size in conformity with a predetermined protocol and transmits the transmission data to the reception apparatus;
acquiring a reception time of an acknowledgement packet returned from the reception apparatus that has received the transmission packet to the data transmission apparatus; and
calculating an available bandwidth in a network used to transmit the transmission data using a reception time of the acknowledgement packet when a sum of data sizes of the transmission data in a predetermined time is double or more the predetermined size.

### [Supplementary Note 16]

A non-transitory computer-readable medium that stores a program causing a processor to execute processes including:
dividing transmission data into one or more transmission packets in units of a predetermined size in conformity with a predetermined protocol;
transmitting the transmission packet to a reception apparatus;
receiving an acknowledgement packet for the transmission packet from the reception apparatus;
acquiring a reception time of the acknowledgement packet; and
calculating an available bandwidth in a network used to transmit the transmission data using a reception time of the acknowledgement packet when a sum of data sizes of the transmission data in a predetermined time is double or more the predetermined size.

### REFERENCE SIGNS LIST

10 DATA TRANSMISSION APPARATUS
11 DATA TRANSMISSION MEANS
12 BANDWIDTH MEASUREMENT MEANS
21 DATA SIZE ACQUISITION MEANS
22 ACKNOWLEDGEMENT RECEPTION TIME ACQUISITION MEANS
23 AVAILABLE BANDWIDTH CALCULATION MEANS
110 DATA TRANSMISSION APPARATUS
111 DATA TRANSMISSION UNIT
112 BANDWIDTH MEASUREMENT UNIT
113 BANDWIDTH PREDICTION UNIT
121 DATA SIZE ACQUISITION UNIT
122 ACKNOWLEDGEMENT RECEPTION TIME ACQUISITION UNIT
123 AVAILABLE BANDWIDTH CALCULATION UNIT
130 RECEPTION APPARATUS
150 NETWORK
200 MOBILE BODY
201 PERIPHERAL MONITORING SENSOR
202 VEHICLE SENSOR
203 VEHICLE CONTROL ECU

What is claimed is:

1. A bandwidth measurement apparatus comprising:
at least one memory storing instructions; and
at least one processor configured to execute the instructions to:
acquire a data size of transmission data transmitted to a reception apparatus from a data transmission apparatus that divides data into one or more transmission packets in units of a predetermined size in conformity with a predetermined protocol and transmits the transmission data to the reception apparatus;
acquire a reception time of an acknowledgement packet returned from the reception apparatus that has received the transmission packet to the data transmission apparatus; and
calculate an available bandwidth in a network used to transmit the transmission data using a reception time of the acknowledgement packet when a sum of data sizes of the transmission data in a predetermined time is double or more the predetermined size.

2. The bandwidth measurement apparatus according to claim 1, wherein the at least one processor is configured to execute the instructions to calculate the available bandwidth based on the predetermined size and an interval between reception times of two acknowledgement packets for two transmission packets transmitted from the data transmission apparatus to the reception apparatus.

3. The bandwidth measurement apparatus according to claim 1, wherein the at least one processor is configured to execute the instructions to calculate the available bandwidth for each pair of transmission packets of which a payload data size is the predetermined size using the interval between the reception times of the acknowledgement packets for the pair of transmission packets, and calculate an average of the available bandwidths calculated for each pair as the available bandwidth.

4. The bandwidth measurement apparatus according to claim 3, wherein
the transmission packets comprise sequence numbers, and
the at least one processor is configured to execute the instructions to calculate an available bandwidth using an interval between the reception times of the acknowledgement packets for the pair of transmission packets of which the sequence numbers are consecutive.

5. The bandwidth measurement apparatus according to claim 1, wherein
the predetermined protocol is a transmission control protocol (TCP), and
the predetermined size is a maximum segment size (MSS) in the TCP.

6. The bandwidth measurement apparatus according to claim 1, wherein the at least one processor is configured to execute the instructions to not calculate the available bandwidth when an acknowledgement packet for the transmission packet is not received in the data transmission apparatus within a predetermined time after transmission of the transmission packet.

7. The bandwidth measurement apparatus according to claim 1, wherein the at least one processor is configured to execute the instructions to not calculate the available bandwidth when a data size of the transmission data is less than double of the predetermined size.

8. A data transmission apparatus comprising:
a data transmitter configured to divide transmission data into one or more transmission packets in units of a predetermined size in conformity with a predetermined protocol, transmit the transmission packet to a reception apparatus, and receive an acknowledgement packet for the transmission packet from the reception apparatus; and
the bandwidth measurement apparatus according to claim 1.

9. The data transmission apparatus according to claim 8, wherein the at least one processor is configured to execute the instructions to calculate the available bandwidth based on the predetermined size and an interval between reception times of two acknowledgement packets for two transmission packets transmitted from the data transmission apparatus to the reception apparatus.

10. The data transmission apparatus according to claim 8, wherein the at least one processor is configured to execute the instructions to calculate the available bandwidth for each pair of transmission packets of which a payload data size is the predetermined size using the interval between the reception times of the acknowledgement packets for the pair of transmission packets, and calculate an average of the available bandwidths calculated for each pair as the available bandwidth.

11. The data transmission apparatus according to claim 8, the at least one processor is configured to execute the instructions to predict an available bandwidth based on the measured available bandwidth,
wherein the data transmitter adjusts a data amount of the transmission data in accordance with the predicted available bandwidth.

12. A bandwidth measurement method comprising:
acquiring a data size of transmission data transmitted to a reception apparatus from a data transmission apparatus that divides data into one or more transmission packets in units of a predetermined size in conformity with a predetermined protocol and transmits the transmission data to the reception apparatus;
acquiring a reception time of an acknowledgement packet returned from the reception apparatus that has received the transmission packet to the data transmission apparatus; and
calculating an available bandwidth in a network used to transmit the transmission data using a reception time of the acknowledgement packet when a sum of data sizes of the transmission data in a predetermined time is double or more the predetermined size.

13. A data transmission method comprising:
dividing transmission data into one or more transmission packets in units of a predetermined size in conformity with a predetermined protocol;
transmitting the transmission packet to a reception apparatus;
receiving an acknowledgement packet for the transmission packet from the reception apparatus;
acquiring a reception time of the acknowledgement packet; and
calculating an available bandwidth in a network used to transmit the transmission data using a reception time of the acknowledgement packet when a sum of data sizes of the transmission data in a predetermined time is double or more the predetermined size.

14. The data transmission method according to claim 13, further comprising:
predicting an available bandwidth based on the calculated available bandwidth; and
adjusting a data amount of the transmission data according to the predicted available bandwidth.

15.-16. (canceled)
